(19) United States
(12) Patent Application Publication
(10) Pub. No.: US 2025/0098764 A1
(43) Pub. Date: Mar. 27, 2025

(54) AEROSOL GENERATING DEVICE

(71) Applicant: KT&G CORPORATION, Daejeon (KR)

(72) Inventors: Hwikyeong AN, Seoul (KR); Daenam HAN, Seoul (KR)

(73) Assignee: KT&G CORPORATION, Daejeon (KR)

(21) Appl. No.: 18/728,590

(22) PCT Filed: Jan. 16, 2023
(86) PCT No.: PCT/KR2023/000731

§ 371 Date: Jul. 12, 2024

(30) Foreign Application Priority Data
Jan. 19, 2022 (KR) 10-2022-0007996

(51) Int. Cl. A24F 40/46; A24F 40/20; A24F 40/465; A24F 40/48; H05B 3/42

(52) U.S. Cl. CPC A24F 40/46; A24F 40/20; A24F 40/465; A24F 40/48; H05B 3/42

(57) ABSTRACT

An aerosol generating device is provided. The aerosol generating device includes: a pipe having an elongated shape defining an insertion space, wherein the pipe comprises a bottom portion positioned relative to a lower portion of the insertion space; and a heater configured to heat the insertion space, wherein the bottom portion is recessed downward relative to the insertion space.

### TECHNICAL FIELD

The present disclosure is related to an aerosol generating device.

### BACKGROUND ART

An aerosol generating device is a device that extracts certain components from a medium or a substance by producing an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol generating devices has been conducted.

### DISCLOSURE

### Technical Problem

It is an objective of the present disclosure to solve the above and other problems.

It is another objective of the present disclosure to allow air to be evenly distributed in a stick.

It is yet another objective of the present disclosure to improve the flow efficiency of air and/or aerosol in a device.

It is yet another objective of the present disclosure to prevent fixation or sticking of a substance generated from a stick to a device.

### Technical Solution

According to one aspect of the subject matter described in this application, an aerosol generating device includes: a pipe having an elongated shape defining an insertion space, wherein the pipe comprises a bottom portion positioned relative to a lower portion of the insertion space; and a heater configured to heat the insertion space, wherein the bottom portion is recessed downward relative to the insertion space.

### Advantageous Effects

According to at least one of the embodiments of the present disclosure, air may be uniformly distributed in a stick.

According to at least one of the embodiments of the present disclosure, the flow efficiency of air and/or aerosol in a device may be improved.

According to at least one of the embodiments of the present disclosure, a substance generated from a stick may be prevented from sticking to a device.

The additional scope of applicability of the present disclosure will be apparent from the following detailed description. However, those skilled in the art will appreciate that various modifications and alterations are possible, without departing from the idea and scope of the present disclosure, and therefore it should be understood that the detailed description and specific embodiments, such as the preferred embodiments of the present disclosure, are provided only for illustration.

### DESCRIPTION OF DRAWINGS

FIGS. 1 to 9 illustrate examples of an aerosol generating device according to embodiments of the present disclosure.

### MODE FOR INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

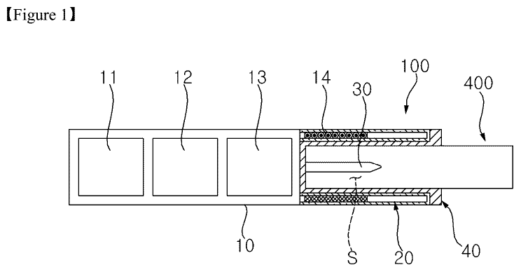

Referring to FIG. 1, an aerosol generating device 100 may include at least one of a battery 11, a controller 12, a sensor 13, and an induction coil 14. The aerosol generating device 100 may include a body (10, 20). At least one of the battery 11, the controller 12, the sensor 13, and the induction coil 14 may be disposed in a lower body 10 of the aerosol generating device 100. An upper body 20 of the aerosol generating device 100 may be coupled to an upper end of the lower body 10, or may be integrally formed with the lower body 10.

A pipe 40 may be disposed inside the upper body 20. The pipe 40 may define an insertion space S. The insertion space S may be open upward. The pipe 40 may cover a lateral portion and a bottom of the insertion space S. A stick 400 may be inserted into the insertion space S.

The induction coil 14 may be installed in the upper body 20. The induction coil 14 may surround the insertion space S. A heater module 30 may be installed in the upper body 20. The heater module 30 may be disposed in the insertion space S.

The induction coil 14 may surround the insertion space S where the heater module 30 is disposed. The induction coil 14 may surround the heater module 30. The heater module 30 may be heated by a magnetic field produced by an AC current flowing through the induction coil 14. The magnetic field may pass through the heater module 30 and generate an eddy current in the heater module 30. The current may cause heat to be generated in the heater module 30. Alternatively, without the need for the induction coil 14, the heater module 30 may generate heat directly using a current received from the battery 11.

The stick 400 may be inserted into the insertion space S. One end of the stick 400 may be exposed to an outside of the upper body 20. The heater module 30 may pass through an end portion of the stick 400 to be inserted into the stick 400. The stick 400 may be heated by the heater module 30. A user may inhale air while holding the one end of the stick 400 exposed to the outside in his or her mouth.

The battery 11 may supply power to operate components of the aerosol generating device 100. The battery 11 may supply power to at least one of the controller 12, the sensor 13, the induction coil 14, and the heater module 30. The battery 11 may supply power required to operate a display, a motor, and the like, installed at the aerosol generating device 100.

The controller 12 may control the overall operation of the aerosol generating device 100. The controller 12 may control the operation of at least one of the battery 11, the induction coil 14, and the sensor 13. The controller 12 may control the operation of the display, the motor, and the like, installed at the aerosol generating device 100. The controller 12 may check the state of each of the components of the aerosol generating device 100 to determine whether the aerosol generating device 100 is in an operable state.

The sensor 13 may sense a temperature of the heater module 30. The sensor 13 may be disposed adjacent to the heater module 30 or be disposed in the heater module 30. Based on the temperature of the heater module 30 sensed by the sensor 13, the controller 12 may control the temperature of the heater module 30.

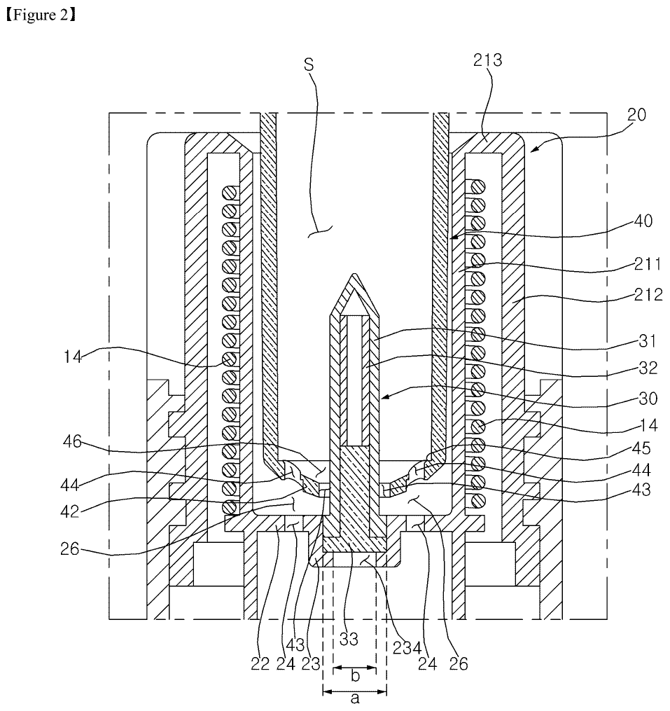

Referring to FIG. 2, an inner wall 211 of the upper body 20 may surround the pipe 40. The inner wall 211 may be elongated vertically. The inner wall 211 may extend in a circumferential direction. The induction coil 14 may surround the inner wall 211 of the upper body 20. The induction coil 14 may be disposed between the inner wall 211 and an outer wall 212 of the upper body 20. An upper wall 213 of the upper body 20 may connect an upper end of the inner wall 211 and an upper end of the outer wall 212 to thereby cover a gap between the inner wall 211 and the outer wall 212.

A flange 22 may be connected to a lower portion of the inner wall 211. The flange 22 may face a bottom portion 42 of the pipe 40. The flange 22 may be formed in a direction intersecting a direction in which the inner wall 211 extends. The flange 22 may have a disk shape. The flange 22 may fix a heater rod 31.

The heater module 30 may include the heater rod 31. The heater rod 31 may have a shape elongated vertically. The heater rod 31 may be formed in a hollow shape. The heater rod 31 may have a cylindrical shape. An upper end of the heater rod 31 may have a pointed shape that gradually narrows upward, namely, toward the top. The stick 400 may be inserted into the heater rod 31. The heater rod 31 may be inserted into the stick 400 through a lower end of the stick 400.

The heater module 30 may include a heater 32. The heater rod 31 may accommodate the heater 32 therein. The heater 32 may be protected by the heater rod 31. The heater 32 may be formed in the shape of a film wrapped in a cylindrical shape. The heater 32 may heat the insertion space S. The heater 32 may be a resistive heating heater. The heater 32 may generate heat by receiving a current directly from the battery 11. Alternatively, the heater 32 may generate heat by inducing a current by the induction coil 32. The heater 32 may be disposed at a height corresponding to the induction coil 14, so as to be surrounded by the induction coil 14. The heater rod 31 may be made of a material having high rigidity and thermal conductivity. For example, the heater rod 31 may be made of a ceramic material. The heater 32 may generate heat to heat the heater rod 31, and accordingly, the heater rod 31 may transfer heat to the stick 400 inserted into the insertion space S. As shown, the heater 32 may be formed in a cylindrical shape having a hollow therein. Alternatively, the heater 32 may have a cylindrical shape without a hollow or a shape corresponding to a hollow of the heater rod 31 to fill the hollow of the heater rod 31. The shape of the heater 32 is not limited thereto.

A stopper 33 may block or cover a lower portion of the heater 32, which is inserted into the hollow of the heater rod 31. The stopper 33 may prevent the heater 32 from being separated from the hollow of the heater rod 31. The stopper 33 may be made of a material having excellent heat resistance to cause little or no deformation in shape or breakage due to heat, even when the heater 32 generates heat.

The stopper 33 may have a shape elongated vertically. As shown, the stopper 33 may have an inverted ‘T’ shape. In this case, a width a of a lower end portion of the stopper 33 may be greater than a width of a portion of the stopper 33, which is inserted into the hollow of the heater rod 31. The width a of the lower end portion of the stopper 33 may be equal to a width of an outer circumferential surface of the heater rod 31. The lower end portion of the stopper 33 may cover a lower end of the heater rod 31. As another example, the stopper 33 may have an ‘I’ shape, unlike shown in the drawing.

The flange 22 may be recessed downward to define a mount 23. The mount 23 may be provided at a center of the flange 22. The mount 23 may surround the lower end of the heater rod 31. The lower end of the heater rod 31 may be inserted into and fixed to the mount 23. The stopper 33 may be disposed between the mount 23 and the lower end of the heater rod 31. A lower end of the stopper 33 may be inserted into and fixed to the mount 23. The lower end of the heater rod 31 and/or the lower end of the stopper 33 may be fixed by being press-fitted into the mount 23, by being adhered to an inside of the mount 23 using an adhesive material, or by being insert-injected into the mount 23. The mount 23 may surround the lower end of the heater rod 31.

A mount hole 234 may be formed at a center of a lower end of the mount 23. The mount hole 234 may be formed by insert injection molding. Alternatively, the mount hole 234 may be provided to allow air to escape when press-fitting the heater rod 31 and/or the stopper 33 into the mount 23. Regardless of the shape of the stopper 33, the width a of the stopper 33 may be greater than a width b of the mount hole 234 of the mount 23. Accordingly, the lower end of the stopper 33 may be supported by the lower end of the mount 23, and separation of the stopper 33 from the mount 23 may be prevented.

The flange 22 may be open to define a flange hole 24. The flange hole 24 may be formed on a periphery of the mount 23. A plurality of flange holes 24 may be provided. The plurality of flange holes 24 may be arranged in the circumferential direction around the mount 23. The flange hole 24 may be in communication with an external flow path 26. The external flow path 26 may be referred to as a flow path 26.

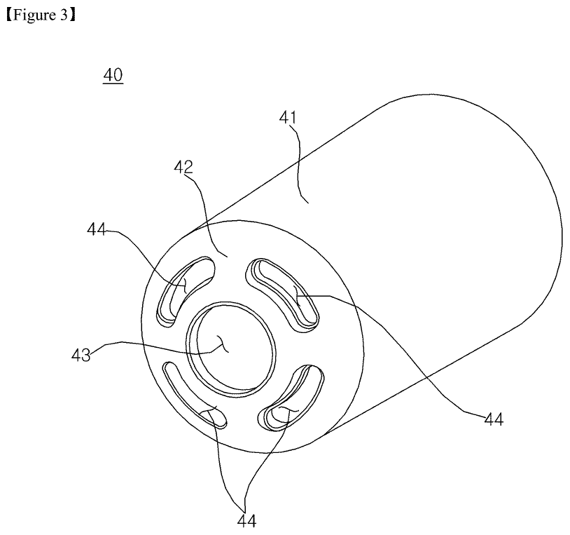

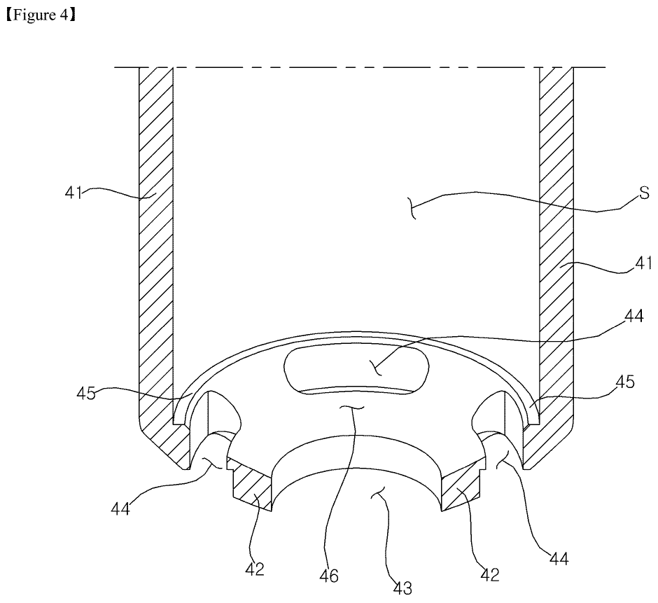

Referring to FIGS. 2 to 4, the pipe 40 may be disposed in a space surrounded by the inner wall 211. The pipe 40 may be coupled or fixed to the inner wall 211. The pipe 40 may define the insertion space S. A lateral wall 41 of the pipe 40 may surround a circumference of the insertion space S. The lateral wall 41 of the pipe 40 may have a hollow cylindrical shape. An upper portion of the insertion space S may be open. The bottom portion 42 of the pipe 40 may cover a lower portion of the insertion space S.

The bottom portion 42 of the pipe 40 may have a shape recessed downward. The bottom portion 42 may be recessed downward from the insertion space S. The bottom portion 42 may have a shape surrounding the lower portion of the insertion space S. A diffusion passage 46 surrounded by the bottom portion 42 may be formed at the lower portion of the insertion space S. The bottom portion 42 may be spaced downward from a support portion 45.

The bottom portion 42 of the pipe 40 may have a shape that gradually widens from the bottom to the top. The bottom portion 42 may gradually widen from a first hole 43 toward the lateral wall 41 of the pipe 40. The bottom portion 42 may gradually narrow downward from the lateral wall 41 in a radially inward direction.

The bottom portion 42 of the pipe 40 may have a curved shape. The bottom portion 42 may have the center of curvature located at the insertion space S. The bottom portion 42 may have a dome shape surrounding the diffusion passage 46.

The bottom portion 42 of the pipe 40 may be open to define the first hole 43. The first hole 43 may be in communication with the insertion space S. The first hole 43 may be open in an up-and-down direction. The first hole 43 may have a circular cross-sectional shape. The first hole 43 may be formed at a center of the bottom portion 42. The first hole 43 may be formed at a position corresponding to the mount 23 or the heater rod 31. The heater rod 31 may protrude to the insertion space S by passing through the first hole 43 from the flange 22. A diameter of the first hole 43 may be greater than an outer diameter of the heater rod 31.

The bottom portion 42 of the pipe 40 may be open to define a second hole 44. The second hole 44 may be in communication with the insertion space S. The second hole 44 may be formed at the center of the bottom portion 42 or in the vicinity of the first hole 43. A plurality of second holes 44 may be provided. The plurality of second holes 44 may be arranged in the circumferential around the center of the bottom portion 42 or around the first hole 43. The second hole 44 may have an elongated cross-sectional shape. The second hole 44 may have a cross-sectional shape with an inward curvature.

The bottom portion 42 of the pipe 40 may be spaced upward from the flange 22 to define the external flow path 26. Air may flow through the external flow path 26. The first hole 43 may be spaced upward from the flange 22. The first hole 43 may allow the insertion space S and the external flow path 26 to communicate with each other. The second hole 44 may be spaced upward from the flange 22. The second hole 44 may allow the insertion space S and the external flow path 26 to communicate with each other.

Accordingly, air may be uniformly or evenly distributed in the stick 400. In addition, a substance generated from the stick 400 may be prevented from sticking to the bottom portion 42. This will be described later.

The support portion 45 may be adjacent to an upper edge of the bottom portion 42 of the pipe 40. The support portion 45 may be formed between an edge of the bottom portion 42 and the lateral wall 41 of the pipe 40. The support portion 45 may protrude inward from an inner circumferential surface of the lateral wall 41 of the pipe 40. The support portion 45 may extend in the circumferential direction. The support portion 45 may have a ring shape. The support portion 45 may face the insertion space S. The support portion 45 may support a lower circumference of the stick 400. The support portion 45 may allow the stick 400 to be disposed on an upper side of the diffusion passage 46. When the stick 400 is inserted into the insertion space S, the diffusion passage 46 may come in contact with the lower end of the stick 400.

Accordingly, the support portion 45 may limit an insertion range of the stick 400. In addition, an edge of the stick 400 may be prevented from being crushed or dented when the stick 400 is inserted into the insertion space S.

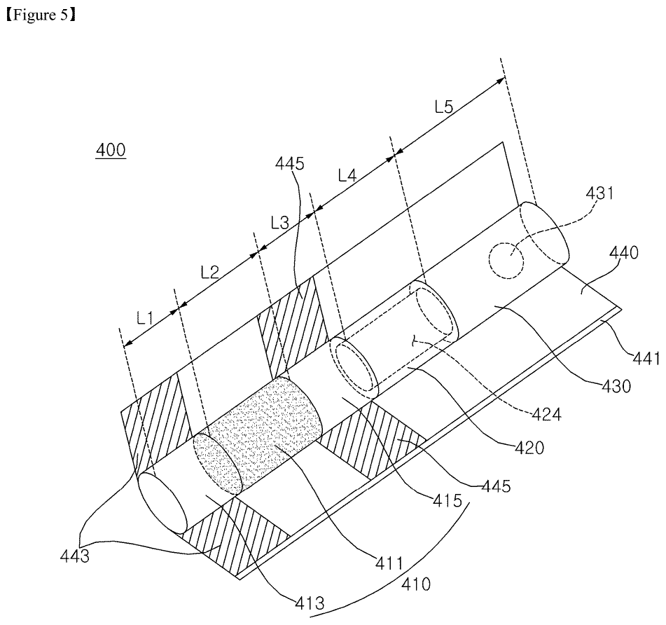

Referring to FIG. 5, the stick 400 may include a medium portion 410. The stick 400 may include a cooling portion 420. The stick 400 may include a filter portion 430. The cooling portion 420 may be disposed between the medium portion 410 and the filter portion 430. The stick 400 may include a wrapper 440. The wrapper 440 may wrap the medium portion 410. The wrapper 440 may wrap the cooling portion 420. The wrapper 440 may wrap the filter portion 430. The stick 400 may have a cylindrical shape.

The medium portion 410 may include a medium 411. The medium portion 410 may include a first medium cover 413. The medium portion 410 may include a second medium cover 415. The medium 411 may be disposed between the first medium cover 413 and the second medium cover 415. The first medium cover 413 may be disposed at one end of the stick 400. The first medium cover 413 may cover a lower side of the medium 411. The second medium cover 415 may cover an upper side of the medium 411. The medium portion 410 may have a length of 24 mm. Accordingly, the medium 411 may be prevented from being separated from the stick 400. The first medium cover 413 may be excluded.

The medium 411 may include a multicomponent substance. The substance contained in the medium 411 may be a multicomponent flavoring substance. The medium 411 may contain 5 to 30% of an aerosol generating substance. The medium 411 may be made of shredded tobacco leaves, granules, reconstituted tobacco leaves, or the like. For example, each of the plurality of granules may have a size of 0.4 mm to 1.12 mm. The granules may account for approximately 70% of the volume of the medium 411. The medium 411 may be a mixture of granules and reconstituted tobacco leaves or a mixture of shredded tobacco leaves and reconstituted tobacco leaves. The medium 411 may have a length (L2) of 10 mm.

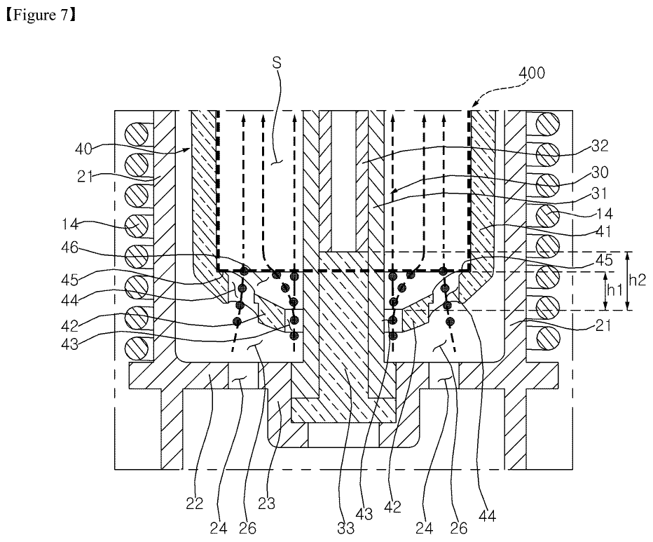

The first medium cover 413 and the second medium cover 415 may be made of a material having high heat resistance. For example, the first medium cover 413 may be made of an acetate material. The second medium cover 415 may be made of an acetate material. The first medium cover 413 may be made of a paper material. The second medium cover 415 may be made of a paper material. At least one of the first medium cover 413 and the second medium cover 415 may be made of a paper material to be crumpled with wrinkles, and a plurality of gaps may be formed between the wrinkles so as to allow air to flow therethrough. Each of the gaps may be smaller than each of the granules of the medium 411. The heater rod 30 may be inserted into the medium 411 through the first medium cover 413 (see FIG. 7).

The first medium cover 413 may include a flavoring substance. An airflow may pass through the first medium cover 413 to entrain or carry the flavoring substance contained in the first medium cover 413. In addition, the heater 32 (see FIG. 7) may transfer heat, which is low heat, to the first medium cover 413, so as to heat a flavor component contained in the first medium cover 413, thereby generating an aerosol.

A length L1 of the first medium cover 413 may be less than a length L2 of the medium 411. A length L3 of the second medium cover 415 may be less than the length L2 of the medium 411. The length L1 of the first medium cover 413 may be designed to have an appropriate thickness to support the medium 411 or to prevent damage of the medium 411. The length L1 of the first medium cover 413 may be 1 mm or more. The length L1 of the first medium cover 413 may be 4 mm to 10 mm. The length L1 of the first medium cover 413 may be 7 mm. The length L2 of the second medium cover 415 may be 7 mm. Accordingly, separation of the medium 411 from the medium portion 410 and the stick 400 may be prevented. In addition, the amount of heat, which is generated from the heater 32, transferred to the flange 50 over the lower end of the stick 400 may be reduced, and thermal deformation between coupling components may be prevented to thereby improve the structural stability.

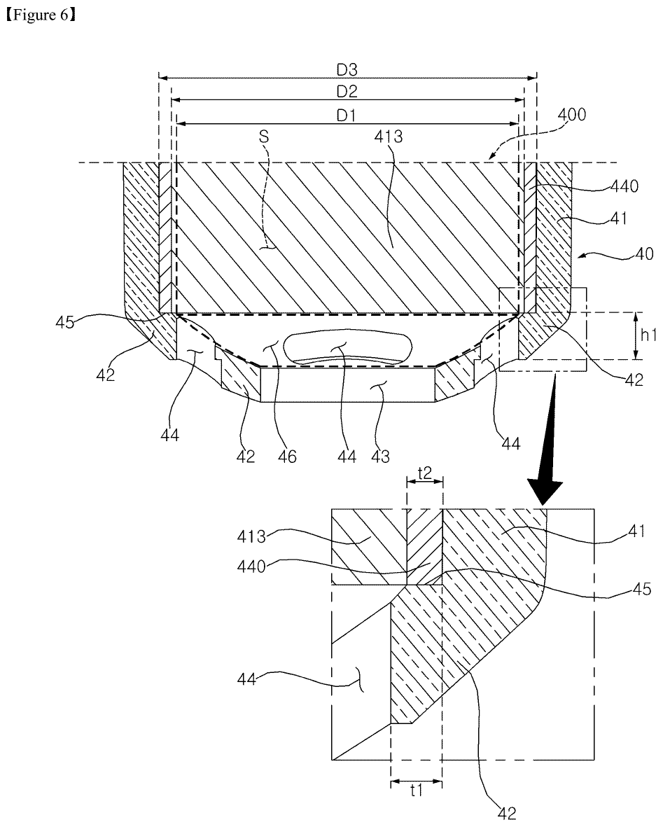

The cooling portion 420 may have a cylindrical shape. The cooling portion 420 may have a hollow shape. The cooling portion 420 may be disposed between the medium portion 410 and the filter portion 430. The cooling portion 420 may be disposed between the second medium cover 415 and the filter portion 430. The cooling portion 420 may be formed in the shape of a tube that surrounds a cooling path 424 formed therein. The cooling portion 420 may have a thickness greater than a thickness of the wrapper 440. The cooling portion 420 may be made of a paper material thicker than that of the wrapper 440. A length L4 of the cooling portion 420 may be equal or similar to the length L2 of the medium 411. The length L4 of each of the cooling portion 420 and the cooling path 424 may be 10 mm. When the stick 400 is inserted into the aerosol generating device 100 (see FIGS. 6 and 7), at least a portion of the cooling portion 420 may be exposed to the outside of the aerosol generating device 100.

Accordingly, the cooling portion 420 may support the medium portion 410 and the filter portion 430, and may achieve the rigidity of the stick 400. In addition, the cooling portion 420 may support the wrapper 440 between the medium portion 410 and the filter portion 430, and may provide a portion to which the wrapper 440 is adhered. In addition, heated air and aerosol may be cooled while passing through the cooling path 424 in the cooling portion 420.

The filter portion 430 may be configured as a filter made of an acetate material. The filter portion 430 may be disposed at another end of the stick 400. When the stick 400 is inserted into the aerosol generating device 100 (see FIGS. 6 and 7), the filter portion 430 may be exposed to the outside of the aerosol generating device 100. A user may inhale air while holding the filter portion 430 in his or her mouth. A length L5 of the filter portion 430 may be 14 mm. A capsule 431 may be disposed in the filter portion 430. The capsule 431 may contain a flavoring substance. The user may change the flavor of the stick 400 by bursting the capsule 431.

The wrapper 440 may wrap or surround the medium portion 410, the cooling portion 420, and the filter portion 430. The wrapper 440 may define an outer shape of the stick 400. The wrapper 440 may be made of a paper material. An adhesive portion 441 may be formed at one edge of the wrapper 440. The wrapper 440 may surround the medium portion 410, the cooling portion 420 and the filter portion 430, and the adhesive portion 441 formed at the one edge of the wrapper 440 and another edge of the wrapper 440 may be adhered to each other. The wrapper 440 may surround the medium portion 410, the cooling portion 420, and the filter portion 430, but may not cover one end and another end of the stick 400.

Accordingly, the wrapper 440 may fix the medium portion 410, the cooling portion 420, and the filter portion 430, and may prevent these components from being separated from the stick 400.

A first thin film 443 may be disposed at a position corresponding to the first medium cover 413. The first thin film 443 may be disposed between the wrapper 440 and the first medium cover 413, or may be disposed outside the wrapper 440. The first thin film 443 may surround the first medium cover 413. The first thin film 443 may be made of a metal material. The first thin film 443 may be made of an aluminum material. The first thin film 443 may be in close contact with or coated on the wrapper 440.

A second thin film 445 may be disposed at a position corresponding to the second medium cover 415. The second thin film 445 may be disposed between the wrapper 440 and the second medium cover 415, or may be disposed outside the wrapper 440. The second thin film 445 may be made of a metal material. The second thin film 445 may be made of an aluminum material. The second thin film 445 may be in close contact with or coated on the wrapper 440.

Accordingly, when a capacitance sensor for recognizing the stick is provided in the aerosol generating device 100, the capacitance sensor may detect whether the stick 400 is inserted into the aerosol generating device 100.

Referring to FIGS. 6 and 7, the bottom portion 42 of the pipe 40 may be recessed downward from the insertion space S to define the diffusion passage 46 therein. The diffusion passage 46 may be formed between the bottom portion 42 and a lower end of the insertion space S or the lower end of the stick 400. The bottom portion 42 may surround one side of the diffusion passage 46 in a rounded shape. The bottom portion 42 may have the center of curvature located at the diffusion passage 46 side. The lower end of the stick 400 may cover another side of the diffusion passage 46. The diffusion passage 46 may face the medium cover 413 or the medium 411.

The diffusion passage 46 may have a predetermined height h1 in the up-and-down direction or in a longitudinal direction of the pipe 40. The height h1 of the diffusion passage 46 may be a height from the first hole 43 to the lower end of the insertion space S or the lower end of the stick 400. A height h2 of the heater 32 from the bottom portion 42 may be greater than the height h1 of the diffusion passage 46.

Accordingly, when a high-temperature substance generated from the stick 400 falls on the bottom portion 42, the substance may be quickly cooled while passing through the diffusion passage 46, and fixation of the substance caused by sticking to the bottom portion 42 may be prevented.

The first hole 43 may be in communication with the diffusion passage 46. The first hole 43 may be adjacent to a center of the diffusion passage 46. The first hole 43 may be formed by opening in the up-and-down direction. The second hole 44 may be in communication with the diffusion passage 46. The second hole 44 may be adjacent to an edge of the diffusion passage 46. The plurality of second holes 44 may be arranged in the circumferential direction. The second hole 44 may be inclined with respect to the up-and-down direction. The second hole 44 may be disposed below the first hole 43.

The support portion 45 may protrude inward from the inner circumferential surface of the lateral wall 41 of the pipe 40. The support portion 45 may protrude in a thickness direction of the lateral wall 41 of the pipe 40. The support portion 45 may be adjacent to the edge of the diffusion passage 46. The support portion 45 may face the insertion space S. The support portion 45 may be disposed outward relative to the second hole 44. A length t1 of the support portion 45 protruding in the thickness direction of the lateral wall 41 of the pipe 40 may be greater than a thickness t2 of the wrapper 440.

Accordingly, the support portion 45 may support a lower edge of the stick 400. The support portion 45 may support the wrapper 440 of the stick 400. In addition, when the stick 400 is inserted into the insertion space S, an edge portion of the stick 400 may be prevented from being crushed or dented.

An outer diameter D2 of the medium cover 411 or the medium 413 may be equal to an inner diameter D2 of the wrapper 440 surrounding the stick 400. An inner diameter D1 of the support portion 45 may be less than the outer diameter D2 of the medium cover 411 or the medium 413. The inner diameter D1 of the support portion 45 may be less than an outer diameter D3 of the stick 400. Accordingly, air may spread to an edge of the medium 413.

When a user inhales air while holding the stick 400 in his or her mouth, the air may flow into the external flow path 26 through the flange hole 24. The air may be introduced into the diffusion passage 46 from the external flow path 26 through the first hole 43 and/or the second hole 44. The air introduced into the diffusion passage 46 may be diffused to the lower end of the stick 400 through the bottom portion 42 of the pipe 40. The heater 32 may heat the medium 411 to generate an aerosol. The air may pass through the stick 400 to entrain the aerosol and then be delivered to the user.

Accordingly, air may be evenly distributed in the stick 400. In addition, the flow resistance of air may be reduced to thereby improve the flowability of air and suction force.

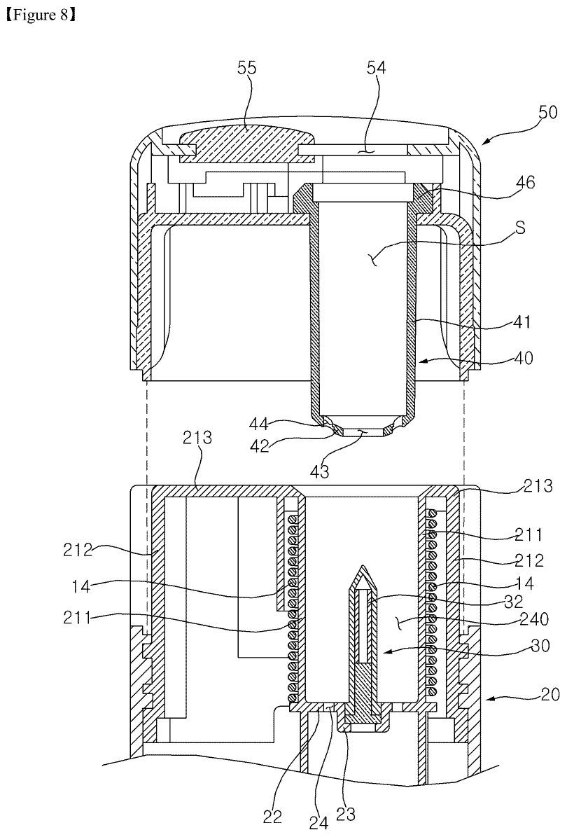

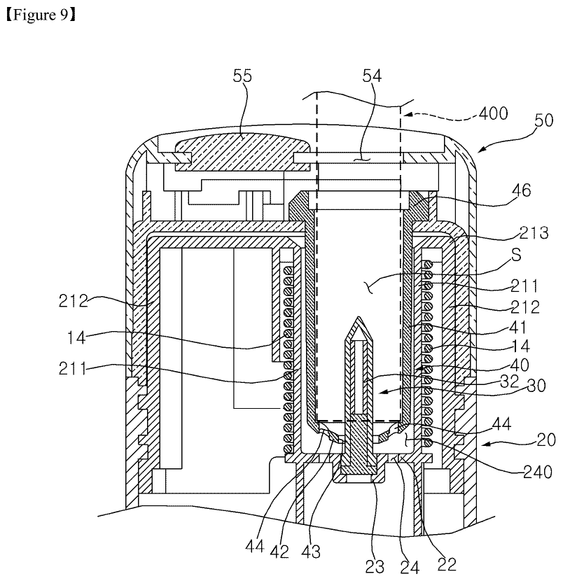

Referring to FIGS. 8 and 9, the upper body 20 may provide an accommodation space 240. The accommodation space 240 may have a cylindrical shape elongated vertically. The inner wall 211 may surround a circumference of the accommodation space 240. A bottom of the accommodation space 240 may be covered by the flange 22. The accommodation space 240 may be in communication with the flange hole 24. The accommodation space 240 may be open upward. The heater rod 31 may be fixed to the flange 22 to protrude to the accommodation space 240 in an elongated manner. The outer wall 212 may be spaced apart from the inner wall 211 in a thickness direction to define a space in which the induction coil 14 is disposed. The induction coil 14 may be wound around the inner wall 211. The induction coil 14 may surround the accommodation space 240.

An upper case 50 may be detachably coupled to the upper body 20. The upper case 50 may cover the upper body 20 and the accommodation space 240. An upper end 46 of the pipe 40 may be coupled or fixed to the upper body 20. The upper case 50 may have an opening 54. The opening 54 may be formed at an upper position of an opening of the insertion space S to correspond to the opening of the insertion space S. The opening 54 may be in communication with the opening of the insertion space S. The upper case 50 may include a cap 55. The cap 55 may be movably coupled to an upper end of the upper case 50. The cap 55 may move to open and close the opening 54 and the opening of the insertion space S.

When the upper case 50 is coupled to the upper body 20, the pipe 40 may be inserted into the accommodation space 240. The pipe 40 may be detachably inserted into the accommodation space 240. The pipe 40 may be surrounded by the inner wall 211 in the accommodation space 240. When the pipe 40 is inserted into the accommodation space 240, the heater rod 31 may protrude to the insertion space S by passing through the first hole 43 formed in the bottom portion 42. The heater 32 may be disposed in the insertion space S. The pipe 40 may be referred to as an extractor 40.

The stick 400 may pass through the opening 54 to be inserted into the insertion space S. The heater rod 31 may be inserted into the stick 400. The heater 32 may heat the medium 411 of the stick 400. When the pipe 40 is separated from the accommodation space 240, the stick 400 inserted into the insertion space S may be separated from the heater rod 31.

Accordingly, the stick 400 may be more easily separated from the heater rod 31. Also, cleaning of the device may be facilitated.

Referring to FIGS. 1 to 9, an aerosol generating device according to one aspect of the present disclosure may include: a pipe having an elongated shape defining an insertion space, wherein the pipe comprises a bottom portion positioned relative to a lower portion of the insertion space; and a heater configured to heat the insertion space, wherein the bottom portion is recessed downward relative to the insertion space.

According to another aspect of the present disclosure, the bottom portion may extends downward from a lateral wall of the pipe in a radially inward direction.

According to another aspect of the present disclosure, the bottom portion may have a dome shape positioned relative to the lower portion of the insertion space.

According to another aspect of the present disclosure, the bottom portion of the pipe may be shaped to define a first hole formed at a center of the bottom portion.

According to another aspect of the present disclosure, the aerosol generating device may further include a body sized to receive the pipe; a flange formed in the body and having a side facing a side of the bottom portion at outside the pipe; and a heater rod coupled to the flange, extending through the first hole and protruding into the insertion space, wherein the heater is located in heater rod.

According to another aspect of the present disclosure, the bottom portion of the pipe may be spaced from the flange to define a flow path through which air flows.

According to another aspect of the present disclosure, the flange may be shaped to define a flange hole formed about a periphery of the flange at which the heater rod is coupled.

According to another aspect of the present disclosure, the bottom portion of the pipe may be shaped to define a second hole that is located radially outward relative to a center of the bottom portion, wherein the second hole may permit communication with the insertion space.

According to another aspect of the present disclosure, the bottom portion of the pipe may be shaped to define a plurality of second holes that are arranged in a circumferential direction relative to a center of the bottom portion wherein the plurality of second holes may permit communication with the insertion space.

According to another aspect of the present disclosure, the aerosol generating device may further include a support portion adjacent to an upper edge of the bottom portion and protruding from an inner circumferential surface of the pipe.

According to another aspect of the present disclosure, the support portion may extend along the inner circumferential surface of the pipe.

According to another aspect of the present disclosure, a width of the support portion may be less than an outer diameter of a stick insertable into the insertion space.

According to another aspect of the present disclosure, the width of the support portion may be less than an inner diameter of a wrapper wrapping the stick.

According to another aspect of the present disclosure, the heater rod may be shaped to define a hollow that is open downward relative to the insertion space, wherein the heater is located in the hollow of the heater rod, and wherein the aerosol generating device may further comprise a stopper covering an opening of the hollow.

According to another aspect of the present disclosure, the aerosol generating device may further include a mount formed by the flange and being recessed downward relative to the insertion space, surrounding a lower end of the heater rod to permit coupling of the heater rod and the mount.

According to another aspect of the present disclosure, the mount may be shaped to define a mount hole located at a lower end of the mount, and wherein a width of the mount hole is less than a width of the stopper, to permit the lower end of the mount to support a lower end of the stopper.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

What is claimed is:

1. An aerosol generating device comprising:
a pipe having an elongated shape defining an insertion space, wherein the pipe comprises a bottom portion positioned relative to a lower portion of the insertion space; and
a heater configured to heat the insertion space,
wherein the bottom portion is recessed downward relative to the insertion space.

2. The aerosol generating device of claim 1, wherein the bottom portion extends downward from a lateral wall of the pipe in a radially inward direction.

3. The aerosol generating device of claim 2, wherein the bottom portion has a dome shape positioned relative to the lower portion of the insertion space.

4. The aerosol generating device of claim 1, wherein the bottom portion of the pipe is shaped to define a first hole formed at a center of the bottom portion.

5. The aerosol generating device of claim 4, further comprising:
a body sized to receive the pipe;
a flange formed in the body and having a side facing a side of the bottom portion at outside the pipe; and
a heater rod coupled to the flange, extending through the first hole and protruding into the insertion space, wherein the heater is located in heater rod.

6. The aerosol generating device of claim 5, wherein the bottom portion of the pipe is spaced from the flange to define a flow path through which air flows.

7. The aerosol generating device of claim 5, wherein the flange is shaped to define a flange hole formed about a periphery of the flange at which the heater rod is coupled.

8. The aerosol generating device of claim 1, wherein the bottom portion of the pipe is shaped to define a second hole that is located radially outward relative to a center of the bottom portion, wherein the second hole permits communication with the insertion space.

9. The aerosol generating device of claim 1, wherein the bottom portion of the pipe is shaped to define a plurality of second holes that are arranged in a circumferential direction relative to a center of the bottom portion wherein the plurality of second holes permit communication with the insertion space.

10. The aerosol generating device of claim 1, further comprising a support portion adjacent to an upper edge of the bottom portion and protruding from an inner circumferential surface of the pipe.

11. The aerosol generating device of claim 10, wherein the support portion extends along the inner circumferential surface of the pipe.

12. The aerosol generating device of claim 10, wherein a width of the support portion is less than an outer diameter of a stick insertable into the insertion space.

13. The aerosol generating device of claim 12, wherein the width of the support portion is less than an inner diameter of a wrapper wrapping the stick.

14. The aerosol generating device of claim 5, wherein the heater rod is shaped to define a hollow that is open downward relative to the insertion space,
wherein the heater is located in the hollow of the heater rod, and
wherein the aerosol generating device further comprises a stopper covering an opening of the hollow.

15. The aerosol generating device of claim 14, further comprising a mount formed by the flange and being recessed downward relative to the insertion space, surrounding a lower end of the heater rod to permit coupling of the heater rod and the mount.

16. The aerosol generating device of claim 15, wherein the mount is shaped to define a mount hole located at a lower end of the mount, and
wherein a width of the mount hole is less than a width of the stopper, to permit the lower end of the mount to support a lower end of the stopper.
